(19) United States
(12) Patent Application Publication
(10) Pub. No.: US 2012/0226562 A1
(43) Pub. Date: Sep. 6, 2012

(54) PERSISTENT METADATA FOR A USER-CONTROLLED POLICY OF PERSONAL DATA DISCLOSURE AND USAGE FOR ONLINE ADVERTISING

(75) Inventors: Geoff Baum, Palo Alto, CA (US); Walter Chang, San Jose, CA (US)

(73) Assignee: ADOBE SYSTEMS INCORPORATED, SAN JOSE, CA (US)

(21) Appl. No.: 13/039,266

(22) Filed: Mar. 2, 2011

(51) Int. Cl. G06Q 30/00

(52) U.S. Cl. 705/14.66

(57) ABSTRACT

A user policy definition of a user policy is received. The user policy definition indicates a user is receptive to receiving an offer and a user-controlled criterion for disclosure of user information. Further, persistent metadata that includes the user policy is generated. A compliance engine sends the user information with the persistent metadata to an offer provider. Further, offer data for a user is received from an offer provider. The offer data indicates a description of content in the offer and an offer criterion indicating a targeting characteristic. In addition, the compliance engine validates that the offer criterion complies with the user-controlled criterion. The offer is sent to the user upon determining that the offer criterion complies with the user-controlled criterion.

### BACKGROUND

1. Field

This disclosure generally relates to advertising. More particularly, the disclosure relates to a user-controlled policy for advertising.

2. General Background

User information is typically collected by a variety of organizations, including data providers, content providers, merchants, and marketers and provided or sold to advertisers and marketers with little restriction. Marketers and advertisers use this user information to target recipients who exhibit characteristics that indicate they would be more likely to positively respond to the online offer. In some cases, a user may have an opportunity to opt out or disallow the collection or use of their information by marketers and advertisers. Nevertheless, much of the time, users have little or no control over how their information is being collected and used by marketers and advertisers. As a result, a user that chooses to receive offers will typically receive a significant amount of advertising that he or she does not want to receive. Further, a user that chooses to opt out of targeted offers or not to receive advertising at all may miss out on certain offers that he or she may like to know about.

In addition, many advertisers use significant resources trying to reach a highly selective audience that exhibits the characteristics of their customers. In some cases, advertisers send what is considered to be junk mail to large groups of users in the hope that at least a small percentage of those individuals will respond to the advertisers' offers for products and/or services. This approach typically wastes advertisers' resources on individuals who do not want to receive such offers, and perhaps more importantly, elicits negative reactions from the recipients, who view the marketing as a nuisance. Another increasingly common tactic is for online advertisers to purchase users' demographic, psychographic and behavioral information in order to more effectively target users who might be interested in the products and/or services offered by the advertiser. Nevertheless, users who do receive offers from such advertisers may not have wanted their information shared with advertisers even if they would have potentially liked the products and/or services offered by the advertiser.

Therefore, current approaches lead to advertisers wasting extensive resources and many users being concerned about privacy issues regarding how their user information is being handled. Accordingly, current approaches to providing offers to users are not efficient for either the offer provider or the user.

### SUMMARY

In one aspect of the disclosure, a computer program product is provided. The computer program product includes a computer useable medium having a computer readable program. The computer readable program when executed on a computer causes the computer to receive a user policy definition of a user policy that indicates a user is receptive to receiving an offer and a user-controlled criterion for disclosure of user information. Further, the computer readable program when executed on the computer causes the computer to generate persistent metadata that includes the user policy. In addition, the computer readable program when executed on the computer causes the computer to send, from a compliance engine, the user information with the persistent metadata to an offer provider. The computer readable program when executed on the computer causes the computer to receive, from the offer provider, offer data for a user that indicates a description of content in the offer and an offer criterion indicating a targeting characteristic. The computer readable program when executed on the computer causes the computer to validate, at the compliance engine, that the offer criterion complies with the user-controlled criterion. In addition, the computer readable program when executed on the computer causes the computer to send the offer to the user upon determining that the offer criterion complies with the user-controlled criterion.

In another aspect of the disclosure, a process is provided. The process receives a user policy definition of a user policy that indicates a user is receptive to receiving an offer and a user-controlled criterion for disclosure of user information. Further, the process generates persistent metadata that includes the user policy. The process also sends, from a compliance engine, the user information with the persistent metadata to an offer provider. Further, the process receives, from the offer provider, offer data for a user that indicates a description of content in the offer and an offer criterion indicating a targeting characteristic. In addition, the process validates, at the compliance engine, that the offer criterion complies with the user-controlled criterion. The process also sends the offer to the user upon determining that the offer criterion complies with the user-controlled criterion.

In yet another aspect of the disclosure, a system is provided. The system includes a reception module that receives (i) a user policy definition of a user policy that indicates a reception module that receives (i) a user policy definition of a user policy that indicates a user is receptive to receiving an offer and a user-controlled criterion for disclosure of user information and (ii) offer data for a user that indicates a description of content in the offer and an offer criterion indicating a targeting characteristic. Further, the system includes a processor that generates persistent metadata that includes the user policy. In addition, the system includes a compliance engine that (i) sends the user information with the persistent metadata to an offer provider and (ii) validates that the offer criterion complies with the user-controlled criterion. The system also includes a transmission module that sends the offer to the user upon determining that the offer criterion complies with the user-controlled criterion.

### DRAWINGS

The above-mentioned features of the present disclosure will become more apparent with reference to the following description taken in conjunction with the accompanying drawings wherein like reference numerals denote like elements and in which:

FIG. 1 illustrates a user policy compliance system.

FIG. 2 illustrates a user compliance system that provides for analysis of the user information.

FIG. 3 illustrates a process that may be utilized to provide a user policy.

FIG. 4 illustrates a micro-segmentation configuration that may be optionally utilized in conjunction with a user-based policy configuration.

FIG. 5 illustrates a system configuration that may be utilized for micro-segment automatic classification.

### DETAILED DESCRIPTION

A user-defined and controlled policy is persisted in metadata that is transmitted with user information to an offer entity. An offer entity may be an advertiser, marketer, etc. A compliance engine ensures that offer entity complies with the user policy. The user-controlled system allows the user to select the type of offers the user would like to accept based on the user's preferences and interests. The user may define a price at which the user is willing to receive an offer. Accordingly, the user's data becomes a tradable commodity. Further, offer entities may reduce the amount of resources wasted on trying to obtain customers who are not interested in receiving advertising material and not interested in receiving particular types of offers even if they are amenable to receiving offers in general.

In one embodiment, a trusted third-party entity is established. A user may provide user information and an associated set of policies about how the user wants his or her data to be utilized by the trusted third-party entity. The user policy may be transmitted as metadata along with the user information. The trusted third-party entity may then store the user information and the user policy in a secure database. Further, an offer provider may provide offers to the trusted third-party entity. The trusted third party ensures that only offers that are in compliance with the user policy will be matched with to the user.

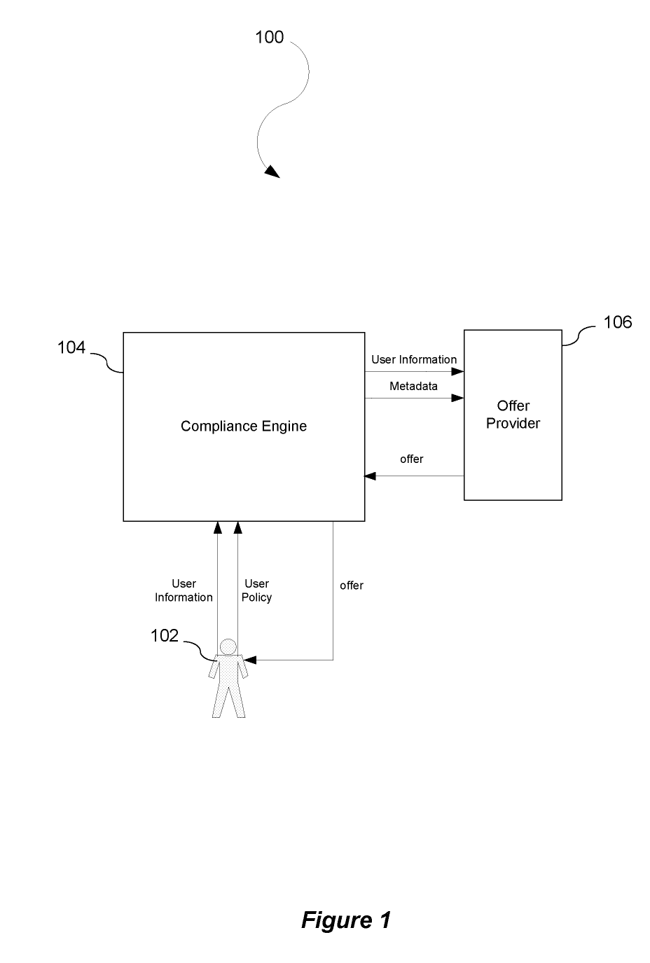

FIG. 1 illustrates a user policy compliance system 100. In one embodiment, a user provides user information and a user-defined policy to a compliance engine 104. The user-defined policy may define a variety of criteria as to how the user information may be utilized, who can see the user information, where the user information may be sent, etc. In one embodiment, the user may define the policy at a graphical user interface. In another embodiment, the policy may be defined by a batch file. In one embodiment, the third-party entity has the compliance engine 104. The compliance engine 104 may be an automated system such as a computing device or a plurality of computing devices. The compliance engine 104 generates metadata based on the user information. After receiving an offer from an offer provider 106, the compliance engine 104 determines if the offer is in compliance with the user policy. If the compliance engine 104 determines compliance, the compliance engine 104 sends the user information and metadata to the offer provider 106. The metadata 106 indicates how the offer provider 106 should utilize the user information. If the offer provider 106 does not utilize the user information in accordance with the user policy as specified by the metadata, an external determination may be made as to that violation. The offer may then be delivered to the user. In one embodiment, a contractual obligation will be utilized that indicates that the offer provider has to follow the system's policies. If a violation is found, the offer provider 106 may have its authorization revoked such that the compliance engine 104 will not recognized the offer entity 106 as an authorized offer provider.

In another embodiment, a user contributes information and defines policies about how their information can be used. Adobe provides a marketplace for the user's information. The user's information travels together with the policies for how their information can be used along with pricing details. The marketer buys access to the user's information, and is contractually obligated to adhere to the user's and trusted third party's policies, when they deliver the subsequent targeted ad or offer to the user based on the user-provided information.

In yet another embodiment, the user contributes information and defines policies about how his or her information can be used. Marketers bid for the right to target those users in ads throughout the web. The trusted third-party acts as an ad network and serves the targeted ads in various sites who are selling inventory based on one or more matches between the user-contributed information, in accordance with the user's policies, and the offer provider's targeting criteria.

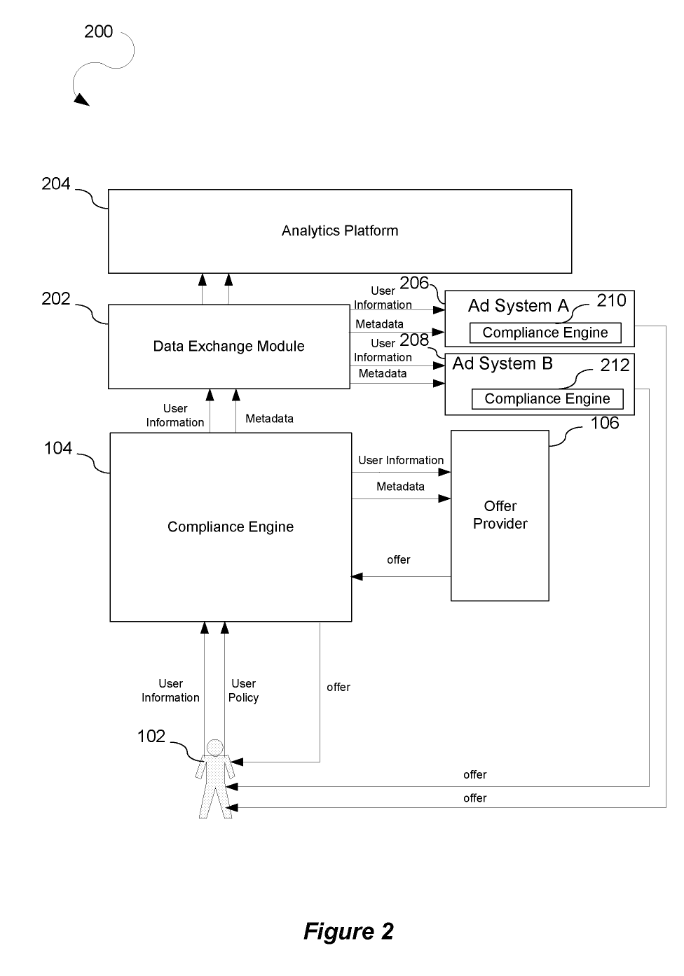

FIG. 2 illustrates a user compliance system 200 that provides for analysis of the user information. In one embodiment, the user may define the user policy to allow for analytics to be performed on the user information. For example, analytics such as web traffic analytics may be performed on the user information. Accordingly, the compliance engine 104 may provide the user information and the metadata to a data exchange module 202. The data exchange module 202 interacts with an analytics platform 204, which performs analytics on the user information.

The user data along with the metadata may travel to external systems in any of the configurations provided for herein. Compliance engines may be located at the receiving systems to ensure compliance with the user policies. In one embodiment, a hub coordinates the data exchanges between the various external systems.

The analytics platform 204 may be internal or external. The data exchange module 202 may send user information and metadata to an advertising system A 206 that has a compliance engine 210. The advertising system A 206 is external. The compliance engine 210 ensures compliance of external offers with the user policy. Further, the data exchange module 202 may send user information and metadata to an advertising system B 208 that has a compliance engine 212. The compliance engine 212 ensures compliance of external offers with the user policy.

In other words, a third-party trusted system would interact with outside advertising systems. A user may define his or her policies of how he or she would like his or her information utilized, e.g., price for disclosure, type of offers in which he or she would be interested, which information he or she is willing to release, etc.—within a third-party trusted system and the other systems that interact with the third-party trusted system, the third-party trusted system would respect those policies in the way they use the user's info and deliver ads and offers to the users.

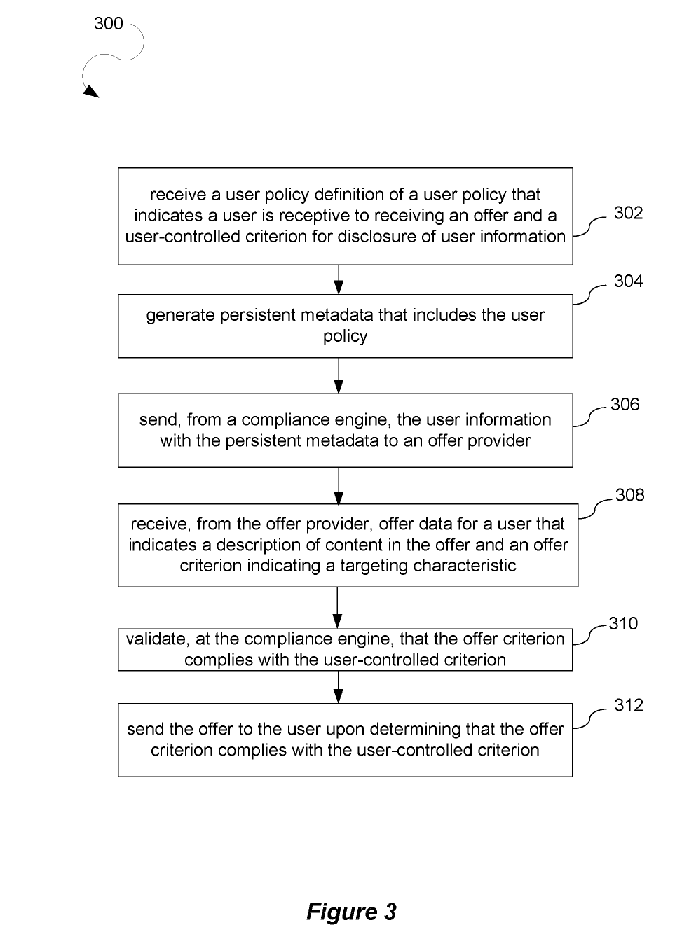

FIG. 3 illustrates a process 300 that may be utilized to provide a user policy. At a process block 302, the process 300 receives a user policy definition of a user policy that indicates a user is receptive to receiving an offer and a user-controlled criterion for disclosure of user information. Further, at a process block 304, the process 300 generates persistent metadata that includes the user policy. The process also sends, from a compliance engine, the user information with the persistent metadata to an offer provider. In addition, at a process block 306, the process 300 receives, from the offer provider, offer data for a user that indicates a description of content in the offer and an offer criterion indicating a targeting characteristic. The content in the offer may be a product, service, etc. The offer criterion may indicate a targeting characteristic such as age, gender, interests, etc. At a process block 308, the process 300 validates, at the compliance engine, that the offer criterion complies with the user-controlled criterion. Further, at a process block 310, the process 300 also sends the offer to the user upon determining that the offer criterion complies with the user-controlled criterion.

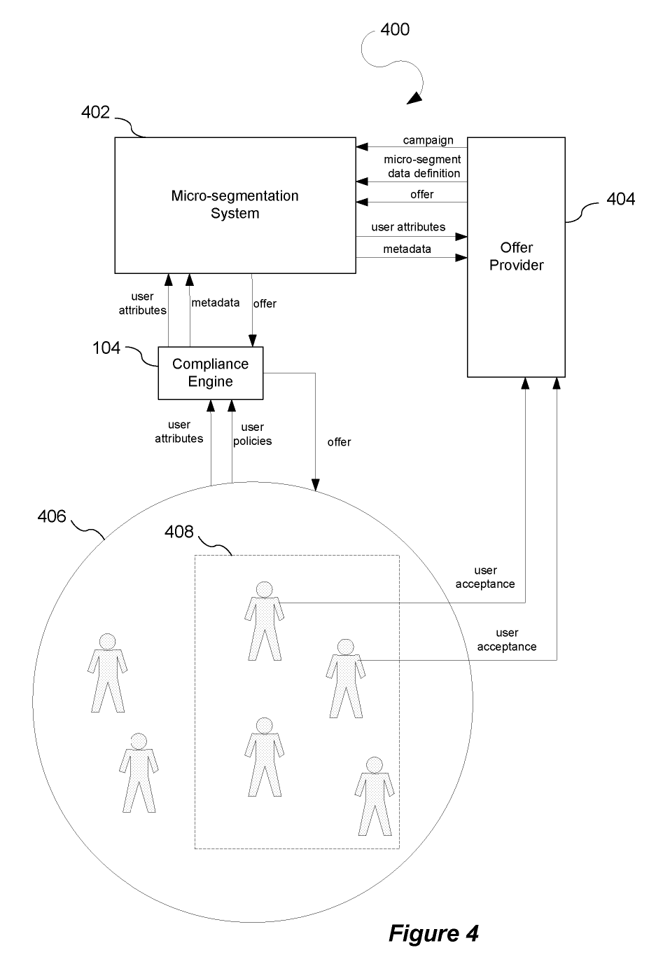

In an alternative embodiment, the user provides permission or does not provide permission to receive offers that are micro-segmented. FIG. 4 illustrates a micro-segmentation configuration 400 that may be optionally utilized in conjunction with a user-based policy configuration. The micro-segmentation configuration 400 is not a necessary component of the user-based policy configuration. The user may define a policy regarding when and how that user is willing to accept advertising. Further, the user may define policies about how marketers are allowed to utilize any information that is provided by the user to a marketer. The user's data is protected according to the user-defined policies. In one embodiment, a digital rights management (“DRM”) system may be utilized to implement the user-based policy configuration in any of the configurations provided for herein. The trusted third-party would protect the user's data with a DRM system. Marketers could essentially license access to the user's data when they meet the criteria for usage as defined by the user-defined policies. The criteria would most likely include a price for access to the data as well as information on which data could be used, by whom, and for what purpose. The marketer would be obligated to pay for and adhere to the policies through the technology of the DRM system as well as by contractual obligation.

Numerous high-value micro-segments within newly created user communities may be identified and created. Advertisers and marketers can automate the creation of customized micro-segments to which they can deliver highly targeted and relevant content across a range of multimedia devices. After the micro-segments are identified, they can be utilized to automate the delivery of content, personalized direct micro-marketing, and micro-promotion campaigns, which target and appeal to the specified tastes, needs, wants, and desires of the member individuals. Micro-marketing is the process by which the system models each user as having different ideas and feelings about a company's products, services, prices, and promotions, and appeals to them in an appropriate manner. A user may be a consumer with respect to any of the configurations provided for herein. The micro-segments provide a finer level of granularity than segments. Accordingly, the micro-segments may assist marketers in recognizing and predicting minute user spending and behavioral patterns. For example, the micro-segments may be utilized to leverage data sources such as core demographics, category spending over time, fine-grained purchase history, and buying intent. Some of these data sources such as purchase history and category spending may be validated as they are coming from third parties, e.g., credit card companies. As a result, marketers are able to provide more accurate, precise, and targeted offers.

Further, membership within micro-segments may be incrementally and continuously updated within micro-segments. In addition, intentional semantics may be automatically detected and extracted utilizing behavioral and natural language processing (“NLP”) information.

Further, recommendations may be quickly and accurately generated regarding content, products and services to users within each micro-segment. A recommendation system may be utilized to perform the recommendations. The recommendation system is a system that employs information clustering and filtering techniques that attempt to recommend information content or product items that are likely to be of interest to a specific user (consumer) based on the cluster or segment he or she is in. In one embodiment, a recommendation system compares a user's behaviors and/or explicit profile to some reference characteristics and then seeks to predict the interest ‘rating’ that a user would give to an item they may have not yet considered. These characteristics may be from the information or product item (using a content-based and/or attribute approach) or the user's social environment (using collaborative filtering approaches).

In one embodiment, each micro-segment includes a specific set of key discriminating features (“KDFs”) that defines a group of attributes utilized by decision makers and a volume or value figure to indicate the micro-segment size. The micro-segmentation system configuration 400 has a micro-segmentation system 402 that is a third-party trusted system between an offer provider merchant 404 and each of a plurality of users 406. The offer provider 404 may be a company selling a product, a company selling a service, a marketing company, an advertising company, or the like that provides a campaign to the micro-segmentation system. The campaign indicates a set of target attributes that the offer provider is looking for in marketing to particular users for a product or service. Accordingly, the set of target attributes refers to the set of attributes the campaign is targeting. As an example, the campaign may be an offer for sale of men's sneakers in the United States of America. The micro-segmentation system 402 receives that campaign. The compliance engine receives user attributes and user policies from each user in the plurality of users 406. The attributes are properties or characteristics. An example of an attribute is gender. Accordingly, the values for the gender attribute may be male or female. The compliance engine 404 receives the offer from the micro-segmentation system 402 and generates metadata for the user policy. The compliance engine 104 determines if the offer is in compliance with the user attributes. If the offer is in compliance with the user attributes, the compliance engine 104 allows the micro-segmentation system 402 to send the user attributes and the metadata to the offer provider 404. The micro-segmentation system 402 then performs a determination of which users in the plurality of users 406 have user attribute values that match the target attributes of the campaign. In other words, the micro-segmentation system 402 evaluates the created micro-segment definitions, attributes values, and value distributions to determine the selectivity of the specific micro-segment. The micro-segmentation system 402 determines a micro-segment 408 that includes users that match the target attributes of the campaign. In one embodiment, all of the target attributes have to equal the user attributes in order for the user to be placed into the micro-segment 408. In another embodiment, a minimum matching score has to be met for the user to be placed into the micro-segment 408. As an example, a user may not have to match all of the attributes, but may match enough of the attributes to generate a score that exceeds the offer provider's minimum threshold and places the user into the micro-segment 408. In another embodiment, a weighting mechanism is utilized to weigh certain attributes as opposed to other attributes in the scoring methodology. For example, an age attribute may have a higher weighting in the scoring calculation than a geographic attribute. In one embodiment, the system compensates for attribute bias to prevent attribute overweighting. Similarly, marketers may be allowed to customize the weightings of micro-segment attributes in determining the selectivity of the micro-segment relative to candidate users.

In one embodiment, after the micro-segmentation system 402 automatically classifies users into the micro-segment 408, the micro-segmentation system 402 sends a micro-segment data definition to the offer provider 404. In one embodiment, the micro-segmentation system 402 captures default definitions and/or training data for classifying existing and/or new users. The quantity of segment definitions may range anywhere from a few to billions based upon the number of ways user attributes are combined and utilized. In another embodiment, that micro-segment data definition does not include personal identity information of the users in the micro-segment. In other words, the plurality of users provide attribute information to the micro-segmentation system 402 on a trusted basis such that the micro-segmentation system does not send information that personally identifies the users to the offer provider 404. The system may not send any data to the offer provider other than representative statistics or general statistics about the micro-segment they defined. As an example, a micro-segment may contain twenty seven thousand three hundred thirty two users. After the offer has been delivered, seventeen thousand three hundred forty four users looked at the offer, three thousand four hundred forty four users clicked on the offer to learn more, and six hundred thirty four users purchased the offer. Further, in one embodiment, the plurality of users 406 provides permission to the micro-segmentation system 402 to send them offers. The micro-segment data definition received by the offer provider 404 provides information such as the number of users in the micro-segment, their attribute values, etc. The offer provider 404 can quickly determine potential interest in a campaign among a target audience, without wasting advertising and resources on people who have no interest in receiving advertising for this specific campaign. As a result, the offer provider 404 can realistically determine if the campaign is economically feasible and the amount of resources that should be dedicated to the campaign, etc. The offer provider can then send an offer to the micro-segmentation system 402 based on the micro-segment data. In other words, the offer provider 404 is not sending the offer directly to the micro-segment 408. After receiving the offer, the micro-segmentation system may then send the offer to the micro-segment. If users in the micro-segment would like to learn more about the offer or accept the offer, the users may then individually contact the offer provider by following a link provided in the offer.

In another embodiment, micro-segment data other than the micro-segment data definition may also be sent to the offer provider 404. As an example, campaign performance statistics may be sent to the offer provider after the delivery of the campaign in addition to the micro-segment data definition.

In one embodiment, the micro-segmentation system 402 also performs recommendations. The micro-segmentation system 102 may deliver a recommendation to the user. In one embodiment, given any user, the micro-segmentation system 402 quickly locates all assigned micro-segments and then utilizes the assigned micro-segments to locate product, service, and/or content offers based on the matching micro-segments to generate specific recommendations. Further, the micro-segmentation system 402 may store data regarding the recommendations upon which the user acts.

In one embodiment, before each user is classified, that user is scored against all relevant micro-segments to determine the most probably classifications. Further, micro-segment classifications may be efficiently assigned to users and searchable in real-time.

The compliance engine may also interact with a recommendation engine as a controller of a source of information. In an alternative embodiment, the compliance engine 104 is part of the micro-segmentation system 402. In yet another embodiment, the compliance engine 104 interacts with the offer provider 404 to provide the user attributes and metadata directly to the offer provider 404.

In any of the configurations provided for herein, the trusted third-party may receive a fee from the offer provider for providing the micro-segment data and/or compliance. In yet another embodiment, the micro-segmentation system can receive a price or price range from a user regarding a product or service. The micro-segmentation system 402 can then provide that price or price range to the offer provider 404 to determine if the offer provider 404 can provide an offer of the product or service at that price. The micro-segmentation system 402 may also ask other offer entities. The user may set a price at which he or she is willing to sell the user data. In another embodiment, the micro-segmentation system 402 may provide a bidding system between the user's price or price range and potential offer entities that bid for that price or price range.

The user data along with the metadata may travel to external systems in any of the configurations provided for herein. Compliance engines may be located at the receiving systems to ensure compliance with the user policies. In one embodiment, a hub coordinates the data exchanges between the various external systems.

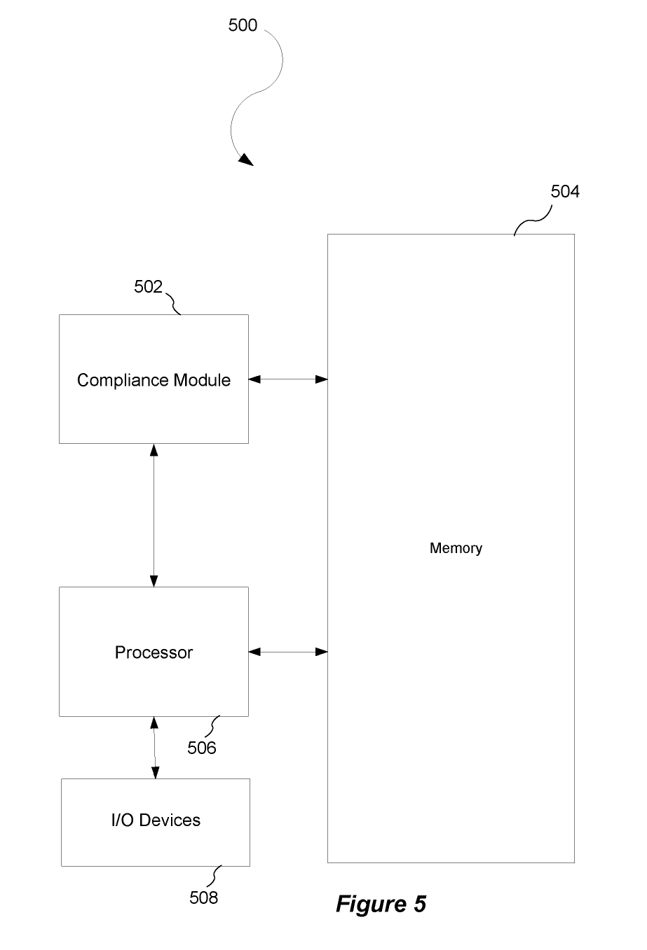

FIG. 5 illustrates a system configuration 500 that may be utilized for micro-segment automatic classification. In one embodiment, a compliance module 502 interacts with a memory 504. In one embodiment, the system configuration 500 is suitable for storing and/or executing program code and is implemented using a general purpose computer or any other hardware equivalents. The processor 506 is coupled, either directly or indirectly, to the memory 504 through a system bus. The memory 504 can include local memory employed during actual execution of the program code, bulk storage, and/or cache memories which provide temporary storage of at least some program code in order to reduce the number of times code must be retrieved from bulk storage during execution.

The Input/Output (“I/O”) devices 508 can be coupled directly to the system configuration 500 or through intervening input/output controllers. Further, the I/O devices 508 may include a keyboard, a keypad, a mouse, a microphone for capturing speech commands, a pointing device, and other user input devices that will be recognized by one of ordinary skill in the art. Further, the I/O devices 508 may include output devices such as a printer, display screen, or the like. Further, the I/O devices 508 may include a receiver, transmitter, speaker, display, image capture sensor, biometric sensor, etc. In addition, the I/O devices 508 may include storage devices such as a tape drive, floppy drive, hard disk drive, compact disk (“CD”) drive, etc. Any of the modules described herein may be single monolithic modules or modules with functionality distributed in a cloud computing infrastructure utilizing parallel and/or pipeline processing.

Network adapters may also be coupled to the system configuration 500 to enable the system configuration 500 to become coupled to other systems, remote printers, or storage devices through intervening private or public networks. Modems, cable modems, and Ethernet cards are just a few of the currently available types of network adapters.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

It should be understood that the processes and systems described herein can take the form of entirely hardware embodiments, entirely software embodiments, or embodiments containing both hardware and software elements. If software is utilized to implement the method or system, the software can include but is not limited to firmware, resident software, microcode, etc.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes, systems, and computer program products. Therefore, it is to be understood that, within the scope of the appended claims, the present processes, systems, and computer program products may be practiced other than as specifically described herein.

We claim:

1. A computer program product comprising a computer useable medium having a computer readable program, wherein the computer readable program when executed on a computer causes the computer to:
receive a user policy definition of a user policy that indicates a user is receptive to receiving an offer and a user-controlled criterion for disclosure of user information;
generate persistent metadata that includes the user policy;
send, from a compliance engine, the user information with the persistent metadata to an offer provider; and
receive, from the offer provider, offer data for a user that indicates a description of content in the offer and an offer criterion indicating a targeting characteristic;
validate, at the compliance engine, that the offer criterion complies with the user-controlled criterion; and
send the offer to the user upon determining that the offer criterion complies with the user-controlled criterion.

2. The computer program product of claim 1, wherein the compliance engine is a system operated by a third-party trusted entity.

3. The computer program product of claim 2, wherein the set of user-controlled criteria includes a time restriction.

4. The computer program product of claim 2, wherein the set of user-controlled criteria includes a delivery type restriction.

5. The computer program product of claim 1, wherein the offer provider is a merchant.

6. The computer program product of claim 1, wherein the offer provider is an advertiser.

7. The computer program product of claim 1, wherein the offer provider is a marketer.

8. A method comprising:
receive a user policy definition of a user policy that indicates a user is receptive to receiving an offer and a user-controlled criterion for disclosure of user information;
generating persistent metadata that includes the user policy;
sending, from a compliance engine, the user information with the persistent metadata to an offer provider; and
receiving, from the offer provider, offer data for a user that indicates a description of content in the offer and an offer criterion indicating a targeting characteristic;
validating, at the compliance engine, that the offer criterion complies with the user-controlled criterion; and
sending the offer to the user upon determining that the offer criterion complies with the user-controlled criterion.

9. The method of claim 8, wherein the compliance engine is a system operated by a third-party trusted entity.

10. The method of claim 9, wherein the user-controlled criteria includes a time restriction.

11. The method of claim 9, wherein the user-controlled criteria includes a delivery type restriction.

12. The method of claim 8, wherein the offer provider is a merchant.

13. The method of claim 8, wherein the offer provider is an advertiser.

14. The method of claim 8, wherein the offer provider is a marketer.

15. A system comprising:
a reception module that receives (i) a user policy definition of a user policy that indicates a user is receptive to receiving an offer and a user-controlled criterion for disclosure of user information and (ii) offer data for a user that indicates a description of content in the offer and an offer criterion indicating a targeting characteristic;
a processor that generates persistent metadata that includes the user policy;
a compliance engine that (i) sends the user information with the persistent metadata to an offer provider and (ii) validates that the offer criterion complies with the user-controlled criterion; and
a transmission module that sends the offer to the user upon determining that the offer criterion complies with the user-controlled criterion.

16. The system of claim 15, wherein the compliance engine is a system operated by a third-party trusted entity.

17. The system of claim 15, wherein the user-controlled criteria includes a time restriction.

18. The system of claim 15, wherein the user-controlled criteria includes a delivery type restriction.

19. The system of claim 15, wherein the offer provider is a merchant.

20. The system of claim 15, wherein the offer provider is an advertiser.
